(19) United States
(12) Patent Application Publication
(10) Pub. No.: US 2014/0151943 A1
(43) Pub. Date: Jun. 5, 2014

(54) VALUABLE METAL RECOVERY APPARATUS

(71) Applicant: NIPPON CRUCIBLE CO., LTD., Tokyo (JP)

(72) Inventors: Tamio Okada, Tokyo (JP); Long Yun Piao, Tokyo (JP); Sadanori Furusawa, Tokyo (JP); Yusuke Sano, Tokyo (JP); Katsuyuki Shirakawa, Osaka (JP); Hideo Yoshikawa, Tokyo (JP)

(73) Assignee: NIPPON CRUCIBLE CO., LTD., Tokyo (JP)

(21) Appl. No.: 13/690,020

(22) Filed: Nov. 30, 2012

(51) Int. Cl. F27D 7/06

(52) U.S. Cl. CPC F27D 7/06
USPC 266/140

(57) ABSTRACT

The present invention provides a valuable metal recovery apparatus capable of discharging clean exhaust gas. The apparatus 1 includes a furnace body 2; a heating container 3; a first combustion burner 10 for supplying heated gas into the furnace body 2; a tower 4 projecting upward from the furnace body 2; a gas combustion chamber 5 communicating with the tower 4 and being used for receiving unburned gas generated upon heating of a material to be treated; a second combustion burner 11 for supplying heated gas into the gas combustion chamber 5; a gas introducing passage 7 for introducing combustion gas generated in the gas combustion chamber 5 into the furnace body 2; a flue 21 for discharging the combustion gas in the furnace body 2 to the outside; and a support 8 supporting the furnace body 2 such that the furnace body 2 can be tilted.

### TECHNICAL FIELD

The present invention relates to a valuable metal recovery apparatus for recovering valuable metals contained in a material to be treated such as waste.

### BACKGROUND ART

Due to a recent increase in industrial waste, etc., it is required that valuable metals, such as precious metals, copper, and aluminum, contained in industrial waste be recovered with high quality at a high yield. A known example of an apparatus for efficiently recovering valuable metals contained in waste is the valuable metal recovery apparatus disclosed in Patent Literature 1.

As illustrated in FIG. 14, the valuable metal recovery apparatus 100 mentioned above includes an apparatus main body 102 accommodating a furnace body 101; a combustion burner 103 for supplying heated gas into the furnace body 101; a flue 104 for discharging combustion gas generated in the furnace body 101 to the outside; and a heating vessel 105 housed in the furnace body 101 and capable of storing waste. The heating vessel 105 has an opening on the top thereof that is openable and closable by means of a lid 106. The heating vessel 105 is provided with a communication path 107 through which the heating vessel and the upper space of the furnace body 101 communicate with each other when the lid 106 is closed.

In the valuable metal recovery apparatus 100 having the above-described structure, a high-temperature combustion gas is supplied from the combustion burner 103 into the furnace body 101 to heat the waste in the heating vessel 105. This initiates melting of the waste in the heating vessel 105, and unburned gas generated from combustible matter (e.g., oils, coating compositions, plastic, rubber, cloth, paper, and wood) contained in the waste is discharged through the communication path 107 into the furnace body 101. The unburned gas is burned together with the combustion gas in the furnace body 101 and discharged from the flue 104.

In the valuable metal recovery apparatus 100 described above, the opening at the top of the heating vessel 105 is closed with the lid 106, and there is thus no or little oxygen inside the vessel, allowing the waste therein to be burned in a reducing atmosphere. As a result, the metals to be melted are prevented from being oxidized, and valuable metals can thus be efficiently recovered.

### CITATION LIST

### Patent Literature

Patent Literature 1: WO 2006/035570

### SUMMARY OF INVENTION

### Technical Problem

However, unburned gas generated from combustible matter contained in waste generally has poor flammability. Therefore, in a case where waste contains a large amount of combustible matter, even if the valuable metal recovery apparatus 100 of Patent Literature 1 is used, achieving complete burning of the unburned gas is difficult, and the unburned gas may undesirably be incorporated into exhaust gas discharged from the flue 104. Further, subjecting the remaining unburned gas to complete burning in the flue 104 and thereafter discharging it would increase the running cost. For this reason, further improvement could be made in terms of making the exhaust gas clean with high efficiency.

The present invention has been accomplished in view of the foregoing problems. An object of the present invention is to provide a valuable metal recovery apparatus capable of efficiently discharging clean exhaust gas.

### Solution to Problem

The above-mentioned object of the present invention can be achieved by a valuable metal recovery apparatus comprising a heating container for storing a material to be treated; a furnace body accommodating the heating container; a first combustion burner for supplying heated gas into the furnace body to heat the heating container; a cylindrical tower detachably provided above the furnace body, the cylindrical tower having an input port for introducing a material to be treated, and the cylindrical tower being used for receiving unburned gas generated upon heating of the material to be treated; a gas combustion chamber communicating with the tower, the gas combustion chamber being used for receiving the unburned gas from the tower; a second combustion burner for supplying heated gas into the gas combustion chamber to burn the unburned gas; a gas introducing passage for introducing combustion gas generated in the gas combustion chamber into the furnace body; a flue integrally provided with the furnace body, the flue being used for discharging the combustion gas in the furnace body to the outside; and a support supporting the furnace body such that the furnace body can be tilted.

According to a preferred embodiment of the present invention, the furnace body has a third combustion burner that is disposed above the heating container and that is used for supplying heated gas to burn the unburned gas discharged into the tower.

According to a preferred embodiment of the present invention, the tower and the furnace body are detachably connected by a connection means. The connection means includes an insertion member provided on the outer peripheral surface of the tower, a receiver provided on the outer peripheral surface of the furnace body, the receiver being used for receiving the insertion member, and an elastic heat insulating material provided inside the receiver. When the insertion member is inserted in the heat insulating material, the tower and the furnace body are airtightly connected to each other. In this embodiment, the heat insulating material preferably comprises ceramic fibers.

According to a preferred embodiment of the present invention, a lattice that is formed from a plurality of rod-shaped members and that is disposed within the tower is further provided. The lattice is formed such that at least a portion of a material to be treated introduced from the input port can temporarily stay thereon. In this embodiment, the lattice is preferably disposed directly above or directly below the third combustion burner. It is more preferable that each of the rod-shaped members be formed in a pipe shape so as to have an internal passage for air, and that each of the rod-shaped members have on its peripheral surface at least one through hole for discharging air that flows through the passage to the outside of the rod-shaped member.

According to a preferred embodiment of the present invention, the furnace body has between itself and the tower a burner mounting unit having an inner diameter greater than that of the tower. The burner mounting unit is provided with the third combustion burner for supplying heated gas into the burner mounting unit. In this embodiment, it is more preferable that the burner mounting unit have in its interior a ring-like threshold member, that the third combustion burner be disposed such that the heated gas flows outside the threshold member, and that the threshold member be provided with a communication path communicating between the inside and outside of the threshold member. The tower may accommodate a cylindrical inner tube such that a space is formed between the inner tube and the inner peripheral surface of the tower; and the third combustion burner may be disposed such that the heated gas flows outside the inner tube. The inner tube may have on its outer peripheral surface slit-like openings for introducing heated gas supplied from the third combustion burner into the inner tube.

According to a preferred embodiment of the present invention, in the interior of the gas combustion chamber, the second combustion burner is disposed in the vicinity of the gas outlet of the tower.

### Advantageous Effects of Invention

The valuable metal recovery apparatus of the present invention can discharge clean exhaust gas with high efficiency.

### BRIEF DESCRIPTION OF DRAWINGS

FIG. 1 is a sectional view schematically illustrating the structure of a valuable metal recovery apparatus according to one embodiment of the present invention.

FIG. 2 shows the structure of a furnace body 2 and a tower 4; the right half of the figure shows a plan view thereof, and the left half of the figure shows a sectional view thereof.

FIG. 3 is a sectional view showing the tilting movement of the furnace body.

FIG. 4 is a sectional view showing the structure of the connection means.

FIG. 5 is as sectional view schematically illustrating the structure of a valuable metal recovery apparatus according to another embodiment of the present invention.

FIG. 6 is a sectional view schematically illustrating the structure of a valuable metal recovery apparatus according to another embodiment of the present invention.

FIG. 7 is a sectional view schematically illustrating the inside structure of the tower of the valuable metal recovery apparatus of FIG. 6.

FIG. 8 is a sectional view schematically illustrating the structure of a valuable metal recovery apparatus according to another embodiment of the present invention.

FIG. 9 is a sectional view schematically illustrating the inside structure of the tower of the valuable metal recovery apparatus of FIG. 8.

FIG. 10 is a sectional view schematically illustrating the structure of a valuable metal recovery apparatus according to another embodiment of the present invention.

FIG. 11 is a sectional view schematically illustrating the structure of a valuable metal recovery apparatus according to another embodiment of the present invention.

FIG. 12 is a plan view schematically illustrating the structure of a lattice.

FIG. 13 is a sectional view of a rod-shaped member.

FIG. 14 is a sectional view of a conventional valuable metal recovery apparatus.

### DESCRIPTION OF EMBODIMENTS

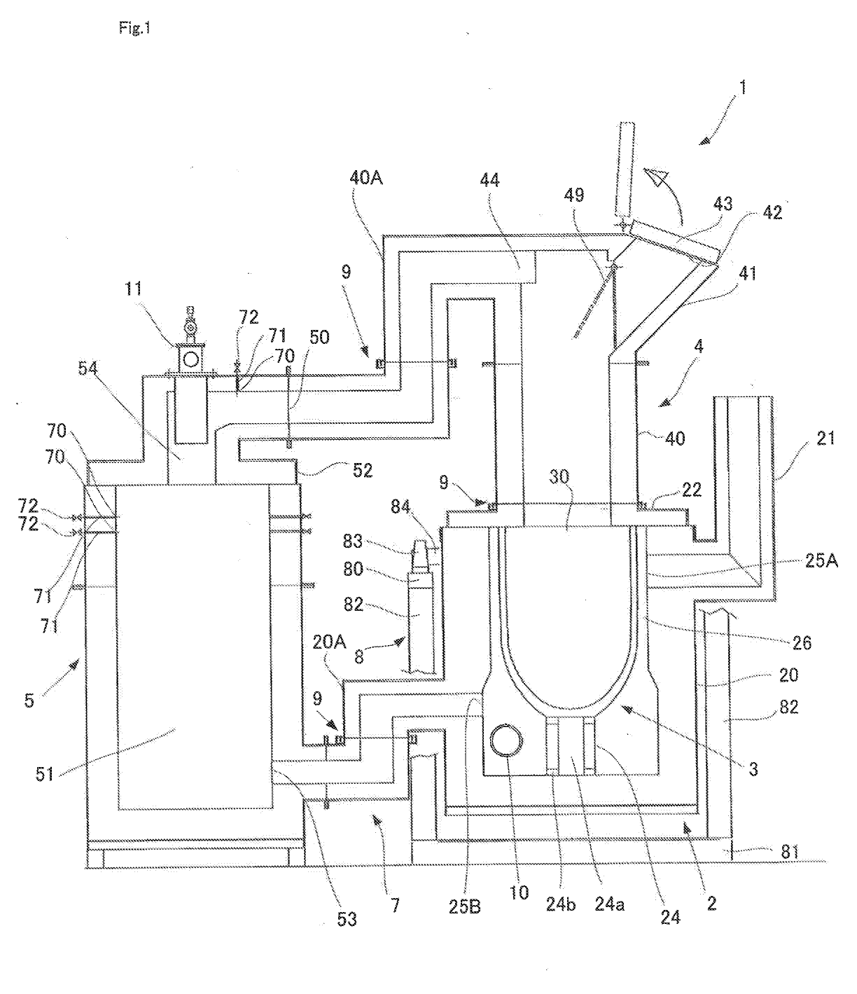

Hereinafter, embodiments of the present invention are described with reference to the attached drawings. FIG. 1 is a sectional view schematically illustrating the structure of a valuable metal recovery apparatus 1 according to one embodiment of the present invention. The valuable metal recovery apparatus 1 of FIG. 1 has a furnace body 2, a first combustion burner 10 and a flue 21, which are attached to the furnace body 2, a heating container 3 accommodated in the furnace body 2, a tower 4 disposed above the furnace body 2, a gas combustion chamber 5 communicating with the tower 4 through a gas discharge passage 6, a second combustion burner 11 attached to the gas combustion chamber 5, a gas introducing passage 7 communicating between the gas combustion chamber 5 and the furnace body 2, and a support 8 supporting the furnace body 2 such that the furnace body 2 can be tilted.

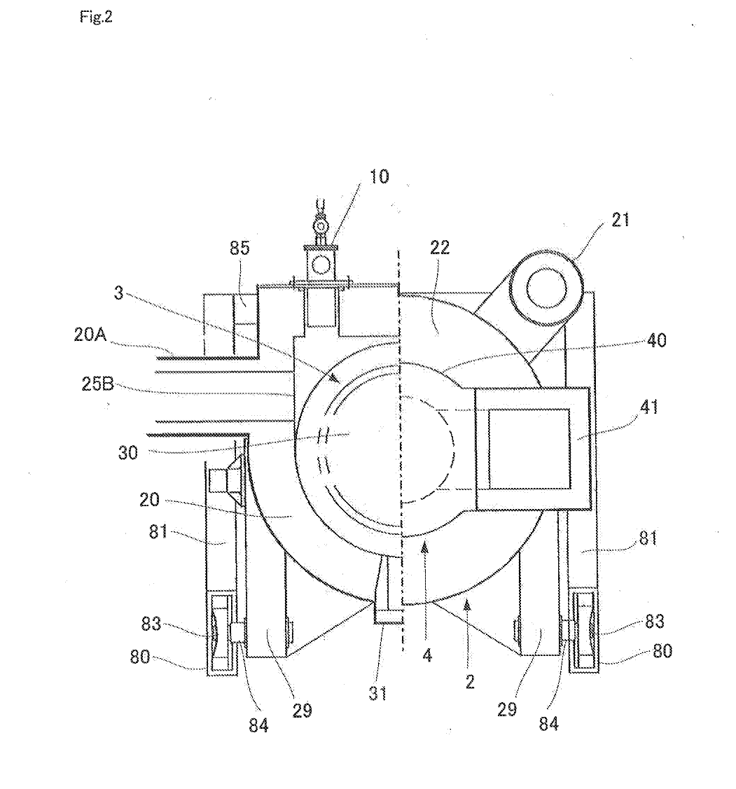

The furnace body 2 is formed such that the iron casing thereof is lined with a fire-resistant material. As shown in FIGS. 1 to 3, the furnace body 2 includes a cylindrical main body 20, a flue 21, and a lid 22. A stand 24 is disposed on the floor surface of the main body 20, and the heating container 3 is placed on the stand 24. A gas outlet 25A is formed at the upper portion of the side wall of the main body 20, and the flue 21 is connected to the gas outlet 25A. The flue 21 is formed such that the pipe member horizontally extending from the gas outlet 25A is bent so as to extend upwardly in the vertical direction.

The stand 24 is in a cylindrical shape having a cavity 24a in the central portion thereof. The lower surface of the stand 24 abuts on the floor surface of the main body 20 while the upper surface thereof abuts on the bottom surface of the heating container 3. At the upper and lower surfaces of the stand 24, concave grooves 24b are formed respectively at equidistant angular positions (e.g., at equal 90 degree intervals). Each groove 24b communicates between the inside and outside of the stand 24. Therefore, a high-temperature combustion gas injected from the first combustion burner 3 into the main body 20 passes through each groove 24b and is introduced into the cavity 24a of the stand 24. This allows not only the peripheral outer surface of the heating container 3 but also the bottom thereof to be heated.

The heating container 3 has a bottom and has an opening 30 at the top. Waste (a material to be treated) from the opening 30 can be stored inside the heating container 3. The heating container 3 is preferably formed of a material excellent in thermal conductivity, such as a graphite crucible. Graphite crucibles are often used as crucible furnaces for melting non-ferrous metals. A graphite crucible is mainly made of flake graphite and silicon carbide, exhibits high thermal conductivity, excellent oxidation resistance, heat resistance, and the mal shock resistance, and has excellent durability in a wide temperature range from high to low temperatures.

A space 26 formed between the side wall of the heating container 3 and the side wall of the main body 20 serves as an upward passage for combustion gas injected from the first combustion burner 10 disposed at the lower portion of the side wall of the main body 20.

The lid 22, which is formed in a ring-like shape, is fixed to the upper surface of the main body 20, and the radially inner peripheral portion of the lid 22 is located inside the opening 30 of the heating container 3. In order to increase the airtightness and to absorb the difference in thermal expansion between the furnace body 2 and the heating container 3, packing having thermal resistance, such as an elastic ceramic fiber blanket, may be provided between the main body 20 and the lid 22.

Each of the first combustion burner 10 and the second combustion burner 11 has a known structure such that it includes a pilot burner for preliminary burning and a main burner for main burning. The combustion load and combustion temperature can be controlled by appropriately adjusting the amount of fuel supplied through a fuel pipe as well as adjusting the flow rate (air ratio) of combustion air supplied through a combustion air feed pipe.

The first combustion burner 10 is provided at a lower portion of the side wall of the main body 20. The first combustion burner 10 is disposed toward a direction tangential to the heating container 3 so that the combustion gas (heated gas) is discharged from the gas outlet 25A and circulates around the heating container 3. The arrangement of the first combustion burner 10 and the gas outlet 25A is not necessarily limited to this embodiment. The arrangement is preferably such that combustion gas injected from the first combustion burner 10 into the main body 20 is sufficiently mixed in the main body 20, and that sufficient combustion time is ensured before the combustion gas is discharged from the gas outlet 25A. The details of the second combustion burner 11 are described hereinafter.

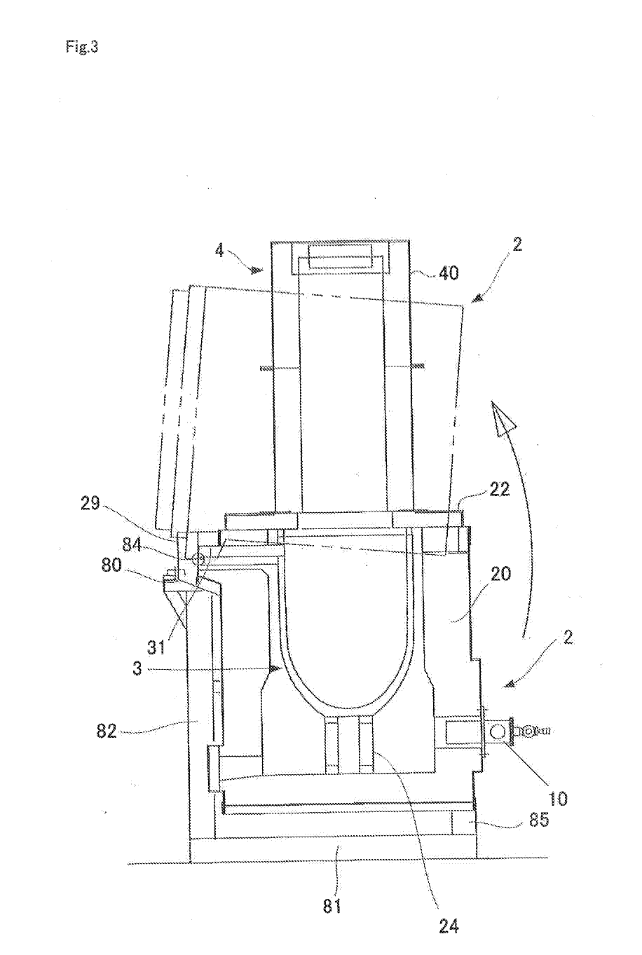

The furnace body 2 is supported by a support 8 in such a manner that the furnace body 2 can be tilted. The support 8 has an upper member 80, a lower member 81 disposed on the floor surface, and a connection member 82 connecting the upper member 80 and the lower member 81. A bearing 83 is fixed to the upper member 80, and a rotatable shaft 84 inserted into the bearing 83 is fixed to a ledge member 29 of the main body 20 so as to allow the furnace body 2 to be tilted as indicated by long dashed double-short dashed lines in FIG. 3. At the rear side of the lower member 81, a support base 85 abutting on the bottom surface of the main body 20 and supporting the rear side of the main body 20 is provided.

The tower 4 provided above the furnace body 2 includes a cylindrical main body 40 and an input port 41 disposed at an upper portion of the main body 40. Similar to the furnace body 2, the tower 4 is also formed such that the iron casing thereof is lined with a fire-resistant material. The lower end of the main body 40 is connected to the upper end of the lid 22 by a connection means 9.

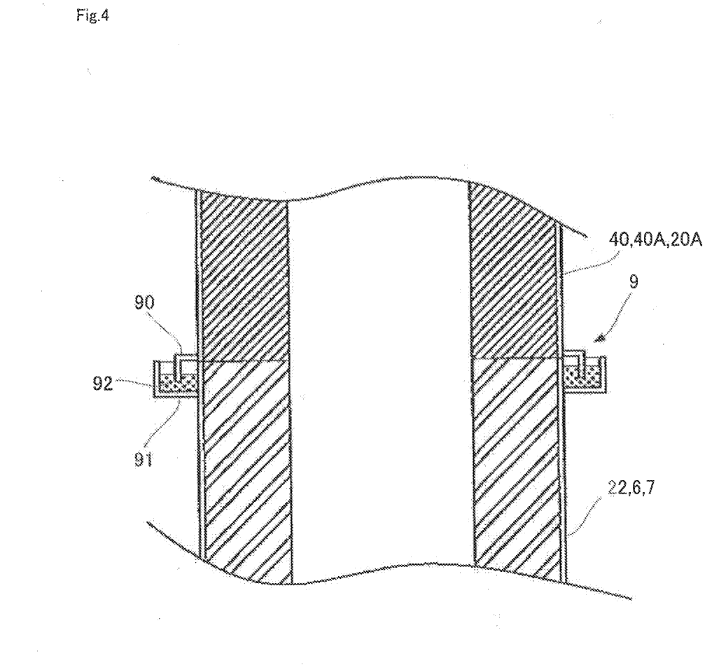

The connection means 9 detachably connects the tower 4 (main body 40) to the furnace body 2 (lid 22). As shown in FIG. 4, the connection means 9 has an insertion member 90 provided about the circumference of the outer peripheral surface of the tower 4 (main body 40) and a receiver 91 provided about the circumference of the outer peripheral surface of the furnace body 2 (lid 22). The receiver 91 is filled with a heat insulating material 92 exhibiting elasticity. As the heat insulating material 92, for example, an elastic heat insulating material, such as ceramic fiber, is preferably used. In addition to the above, various kinds of materials can be used as long as they serve as packing having thermal resistance and elasticity. The insertion member 90 is bent into a hook, and the vertical portion thereof is received in the receiver 91. At this time, the vertical portion of the insertion member 90 is inserted in the heat insulating material 92, thereby allowing the boundary between the tower 4 (main body 40) and the furnace body 2 (lid 22) to be sealed so that the tower 4 (main body 40) is airtightly connected to the furnace body 2 (lid 22). In this way, the tower 4 projecting upward from the furnace body 2 hermetically covers the opening 30 of the heating container 3. As such, the connection means 9 of this embodiment can airtightly connect the furnace body 2 to the tower 4 with a simple configuration, enabling the tower 4 to be easily attached to or removed from the furnace body 2.

Referring back to FIGS. 1 to 3, the input port 41 is used for introducing waste containing valuable metals such as aluminum chips into the heating container 3. An inlet 42, which is disposed at an end of the input port 41, is provided with an input lid 43, which can be opened or closed. The input port 41 has an axis extending in a diagonally upward direction, and the waste introduced from the inlet 42 is directed along the inclined inner peripheral surface of the input port 41 to the main body 40 and drops into the heating container 3.

A gas outlet 44 is provided at an upper portion of the main body 40. A pipe member 40A extending from the gas outlet 44 is connected to an end of a gas discharge passage 6. The other end of the gas discharge passage 6 extends to the gas combustion chamber 5 and is connected to a gas inlet 50. The tower 4 communicates with the gas combustion chamber 5 via the gas discharge passage 6. Unburned gas, such as water vapor and organic substances generated from the waste upon heating of the heating container 3, goes upward inside the tower 4 to be discharged from the gas outlet 44 into the gas combustion chamber 5 through the gas discharge passage 6.

In the middle of the gas discharge passage 6, a circulation fan for circulating the unburned gas may be provided between the tower 4 and the gas combustion chamber 5 such that suction force induced by the rotation of the fan forcibly generates a circulating flow, thereby allowing the unburned gas in the tower 4 to be discharged into the gas combustion chamber 5.

Similar to the tower 4 and the furnace body 2, the gas discharge passage 6 and the tower 4 (the main body 40) are also detachably connected by the connection means 9. While an insertion member 90 is provided about the circumference of the outer peripheral surface of the pipe member extending from the main body 40 of the tower 4, a receiver 91 is provided about the circumference of the outer peripheral surface of the gas discharge passage 6. The vertical portion of the insertion member 90 is inserted into elastic heat insulating material 92 that is used to fill the receiver 91, allowing the boundary between the main body 40 and the gas discharge passage 6 to be sealed so that the main body 40 is airtightly connected to the gas discharge passage 6. As such, the gas discharge passage 6 can be easily attached to or removed from the tower 4.

Similar to the furnace body 2, the gas combustion chamber 5 is also formed such that the iron casing thereof is lined with a fire-resistant material. The gas combustion chamber 5 has an internal combustion space 51. A lid 52 having in its interior a gas flow passage 54 is fixed to the upper surface of the gas combustion chamber 5. The lid 52 is provided with a gas inlet 50, which is connected to the gas discharge passage 6.

In the gas flow passage 54 within the lid 52, a second combustion burner 11 is provided above the combustion space 51 and in the vicinity of the gas inlet 50. Into the combustion space 51, combustion gas (heated gas) is injected from the second combustion burner 11. When combustion gas is injected from the second combustion burner 11 into the combustion space 51, due to the ejector effect of the injected gas flow, the unburned gas discharged from the tower 4 into the gas inlet 50 via the gas discharge passage 6 is drawn into the combustion space 51 with the combustion gas and mixed therewith in the combustion space 51. As a result, the unburned gas is burned in the combustion space 51.

As described above, in this embodiment, when combustion gas is injected from the second combustion burner 11, negative pressure is created around the gas inlet 50 due to the ejector effect of the injected combustion gas. This causes the unburned gas at the gas discharge passage 6 to be drawn from the gas inlet 50 to be injected with the combustion gas into the gas combustion chamber 5. In this way, a circulating flow of the unburned gas is generated from the upstream to the downstream in the gas discharge passage 6, allowing the unburned gas in the tower 4 to be smoothly discharged from the gas discharge passage 6 into the gas combustion chamber 5.

Further, in the gas flow passage 54 of the lid 52, an air supply opening 70 for introducing air from the outside is formed in the vicinity of the second combustion burner 11. The flow rate of the air introduced from the air supply opening 70 can be controlled by adjusting the opening of a valve 72 provided with a pipe 71 connected to the air supply opening 70. By supplying air from the air supply opening 70, the unburned gas introduced into the gas combustion chamber 5 can be actively burned. In addition, because an air flow that goes to the combustion space 51 of the gas combustion chamber 5 is generated, the unburned gas in the gas discharge passage 6 is allowed to be more smoothly discharged into the gas combustion chamber 5.

Accordingly, in this embodiment, a power source is not particularly required for discharging the unburned gas in the tower 4 into the gas combustion chamber 5. The gas combustion chamber 5 can thus be downsized, and the running cost can also be reduced. The arrangement of the second combustion burner 11 in relation to the gas combustion chamber 5 is not necessarily limited to the embodiment described above; the arrangement of the second combustion burner 11 can be appropriately changed as long as it is disposed in the vicinity of the gas inlet 50 within the gas combustion chamber 5.

On the side wall of the gas combustion chamber 5, air supply openings 70 for introducing air from the outside are formed. In this embodiment, a plurality of air supply openings 70 are provided generally at equal intervals in circumferential directions of the cylindrical gas combustion chamber 5; each portion thereof has upper and lower openings. The flow rate of air introduced from each air supply opening 70 can be individually controlled by adjusting the opening of the valve 72 disposed within the pipe 71 connected to each of the air supply openings 70. The number of air supply openings 70 and where to provide them can be suitably adjusted according to, for example, the required air intake amount and the shape of the gas combustion chamber 5. If sufficient air can be introduced into the gas combustion chamber 5 from the second combustion burner 11, the air supply opening 70 is not necessarily provided.

A gas outlet 53 is formed at the lower portion of the gas combustion chamber 5. The gas outlet 53 is connected to one end of a gas introducing passage 7. The other end of the gas introducing passage 7 is connected to a pipe member extending from the gas supply opening 25B disposed at the lower portion of the furnace body 2 (the main body 20). The gas combustion chamber 5 communicates with the furnace body 2 via the gas introducing passage 7 so as to introduce combustion gas generated in the gas combustion chamber 5 into the furnace body 2. In the middle of the gas introducing passage 7, in order to circulate the combustion gas between the furnace body 2 and the gas combustion chamber 5, a circulation system, such as a circulation fan, for generating a circulation flow may be provided so as to forcibly generate a circulating flow to allow the combustion gas in the gas combustion chamber 5 to be introduced into the furnace body 2.

Similar to the tower 4 and the furnace body 2, the gas introducing passage 7 and the furnace body 2 (the main body 20) are also detachably connected by the connection means 9. An insertion member 90 is provided about the circumference of the outer peripheral surface of the pipe member 20A extending from the main body 20 of the furnace body 2 while a receiver 91 is provided about the circumference of the outer peripheral surface of the gas introducing passage 7. The vertical portion of the insertion member 90 is inserted in the elastic heat insulating material 92 that is used to fill the receiver 91, allowing the boundary between the main body 20 and the gas introducing passage 7 to be sealed so that the main body 20 is airtightly connected to the gas introducing passage 7. As such, the gas introducing passage 7 can be easily attached to or removed from the furnace body 2.

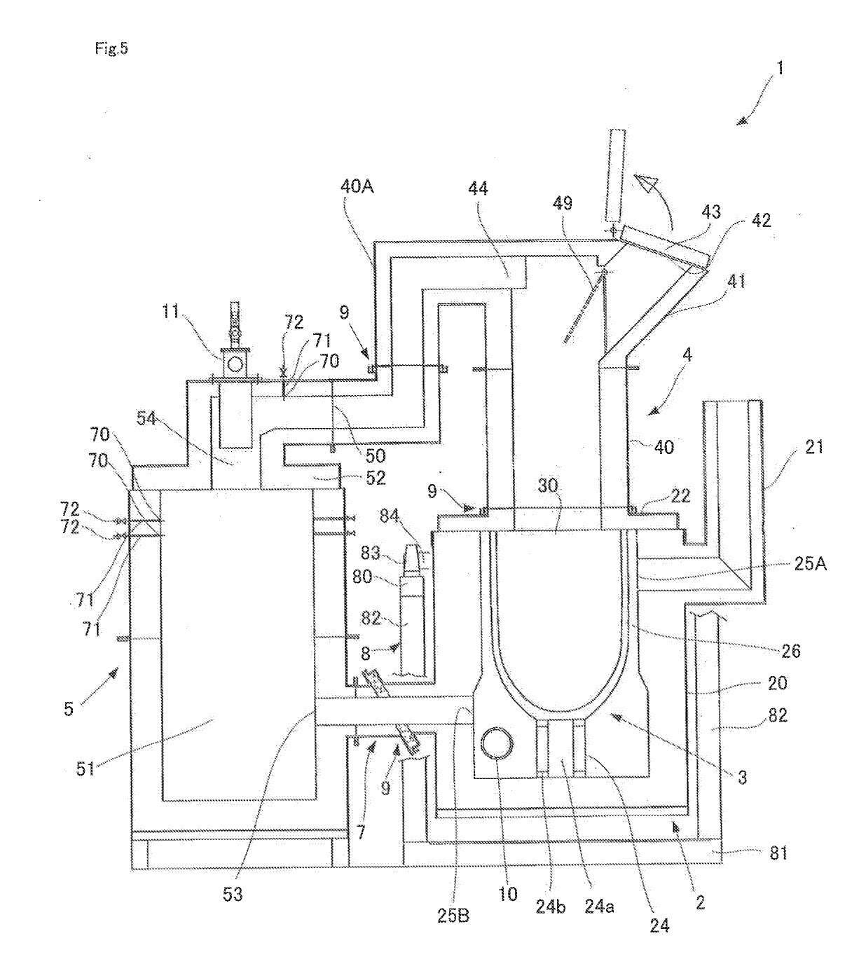

When the main body 20 of the furnace body 2 and the gas combustion chamber 5 are disposed at a close distance so that sufficient space cannot be allocated between the main body 20 and the gas combustion chamber 5, as illustrated in FIG. 5, it is also possible that the insertion member 90 and the receiver 91 of the connection means 9 be disposed in an oblique direction of the outer peripheral surface of the pipe member of the main body 20 and the gas introducing passage 7.

The following specifically describes a method for heat treating waste and recovering valuable metals, using the valuable metal recovery apparatus 1 having the above-described structure. The waste is assumed to be that containing non-ferrous metals, such as aluminum, and combustible waste, such as oils, organic coating compositions, plastic, rubber, cloth, paper, and wood.

First, the input lid 43 of the tower 4 is opened, and waste containing combustible waste, such as those mentioned above, is fed through the inlet 42 into the heating container 3. Next, after the input lid 43 is closed, the first combustion burner 10 is operated, and a high-temperature combustion gas is supplied from the first combustion burner 10 into the main body 20 of the furnace body 2. The combustion gas supplied into the main body 20 heats the entire heating container 3 as it goes up inside the space 26. The internal temperature of the main body 20 heated by the first combustion burner 10 may be suitably adjusted in consideration of the melting temperature of the valuable metals to be recovered. When the waste contains aluminum, such as aluminum beverage cans or aluminum chips, the temperature may be adjusted to about 900° C. The internal temperature of the main body 20 can be desirably determined by adjusting the combustion amount or air ratio by means of, for example, on/off control of the main burner or pilot burner of the first combustion burner 10 while a temperature sensor (not shown) or the like is being monitored.

The upper opening 30 of the heating container 3 is closed by the tower 4, and there is thus no or little oxygen inside the heating container 3. Therefore, heating of the heating container 3 allows valuable metals contained in the waste in the heating container 3 to be melted in a reducing atmosphere. In this embodiment, the stand 24 supporting the heating container 3 has grooves 24b. Therefore, the combustion gas is brought into contact with not only the outer peripheral surface of the heating container 3 but also the bottom surface thereof, thereby enabling the whole heating container 3 to be efficiently heated. By such an indirect heating of the waste in a reducing atmosphere by means of the heat transfer of the heating container 3, the valuable metals can be easily melted while the oxidation of the valuable metals in the waste is suppressed. A carbonization-promoting material, such as coconuts or plastic, may be introduced into the heating container 3 to enhance the reducing atmosphere, if necessary.

The combustible waste, such as oils, organic coating compositions, and plastic, other than valuable metals, is thermally decomposed into a gas upon heating of the heating container 3 and released from the heating container 3. The released gas is discharged as unburned gas through the gas outlet 44 of the tower 4 into the gas combustion chamber 5 via the gas discharge passage 4.

The unburned gas mentioned above is burned into combustion gas by the combustion gas from the second combustion burner 11 in the gas combustion chamber 5. At this time, upon injection of combustion gas from the second combustion burner 11, the unburned gas is drawn into the gas combustion chamber 5, and negative pressure is thereby built up downstream of the gas discharge passage 6. As such, the unburned gas is smoothly discharged from the tower 4 into the gas combustion chamber 5 through the gas discharge passage 6.

The combustion gas injected from the second combustion burner 11 preferably has a temperature of 800° C. or more, and more preferably 850° C. or more, so as to promote complete burning of the unburned gas. The gas introduced into the gas combustion chamber 5 from the air supply opening 70 may be a combustion supporting gas such as oxygen, other than air, so that complete burning of the unburned gas can be promoted in the gas combustion chamber 5.

The combustion gas burned in the gas combustion chamber 5 is supplied into the furnace body 2 from the gas outlet 53 through the gas introducing passage 7 with combustion gas from the second combustion burner 11. The combustion gas introduced into the furnace body 2 from the gas combustion chamber 5 joins the combustion gas from the first combustion burner 10 to be effectively used as a heat source for heating the heating container 3, and is thereafter discharged from the flue 21.

When the gas introduced into the furnace body 2 from the gas combustion chamber 5 contains a portion of unburned gas that was not burned in the gas combustion chamber 5, such an unburned gas is burned by the combustion gas injected from the first combustion burner 10 into the furnace body 2. As such, even if unburned gas is present by any chance in the gas introduced from the gas combustion chamber 5 into the furnace body 2, burning thereof can be completed within the furnace body 2, ensuring complete burning of the unburned gas generated from the waste.

Meanwhile, the valuable metals melted within the heating container 3 are recovered by tilting the furnace body 2 by means of the support 8. Specifically, in a state where the tower 4 and the gas introducing passage 7 are attached to the furnace body 2, the insertion members 90 are pulled out of the respective receivers 91 to remove the tower 4 and the gas introducing passage 7 from the furnace body 2 to allow the furnace body 2 to be movable. Subsequently, as illustrated in FIG. 3, the furnace body 2 is lifted to rotate it about the rotatable shaft 84 to thereby tilt the furnace body 2. This causes the heating container 3 in the furnace body 2 to be tilted, and the valuable metals are then collected through a molten metal discharge port 31. The method for tilting the furnace body 2 can be suitably selected. Such a method may be a method for tilting the furnace body 2 by lifting it with a hydraulic cylinder, a chain, a jack, or the like; a method based on a mechanism in which the furnace body 2 is tilted by rotating a manual handle; or the like.

In the valuable metal recovery apparatus 1 of this embodiment, the unburned gas generated upon burning of the waste is burned in the gas combustion chamber 5 by the combustion gas from the second combustion burner 11 (primary combustion), additionally burned in the furnace body 2 by the combustion gas from the first combustion burner 10 (secondary combustion), and thereafter discharged from the flue 21. Therefore, in the whole apparatus, sufficient time for burning the unburned gas is ensured, promoting complete burning of the unburned gas. As a result, the exhaust gas discharged from the flue 21 can be clean, and the discharge of smoke, odor, dust and ash, and the like, can be prevented.

Further, because the high-temperature combustion gas generated upon burning of the unburned gas is effectively used for, for example, heating the heating container 3 by allowing it to be circulated within the furnace body 2, it is also possible to reduce, for example, fuel consumption of the first combustion burner 10, due to thermal recycling, and not only can valuable metals be efficiently recovered from the waste, but also the combustion heat of combustible waste can be efficiently recovered as a resource.

When valuable metals are collected from the heating container 3 by tilting the furnace body 2, the tower 4 and the gas introducing passage 7, which interfere with the tilting of the furnace body 2, can be easily removed from the furnace body 2 by using the connection means 9. As a result, valuable metals can be easily recovered.

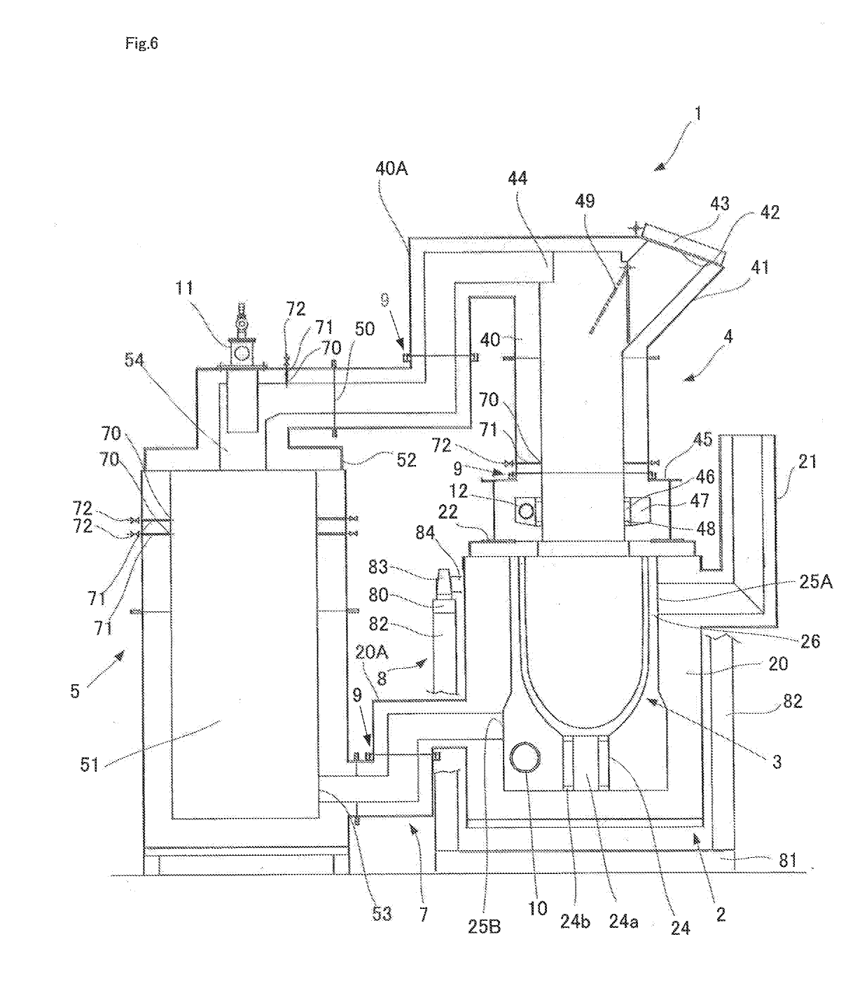

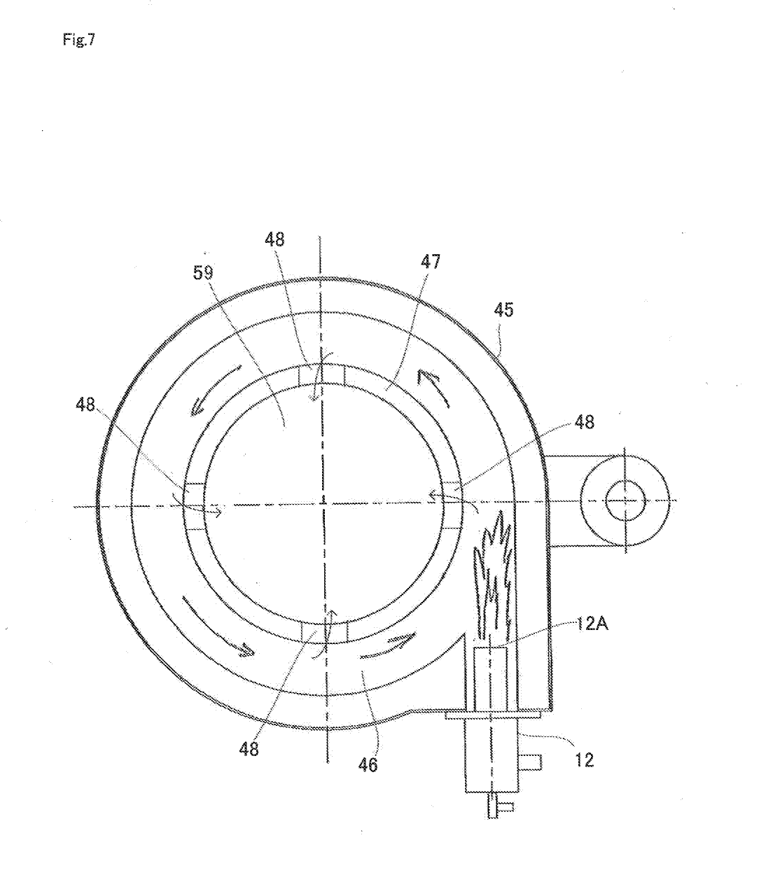

The above describes in detail an embodiment of the present invention. However, the specific mode of the present invention is not limited to the above-described embodiment. For example, as illustrated in FIG. 6, a third combustion burner 12 for supplying combustion gas (heated gas) for burning the unburned gas discharged into the tower 4 may be provided above the heating container 3. In the valuable metal recovery apparatus 1 of FIG. 6, the furnace body 2 is provided with a cylindrical burner mounting unit 45 between the main body 40 of the tower 4. The lower end of the burner mounting unit 45 is fixed to the upper surface of the lid 22 while the upper end thereof is connected to the main body 40 of the tower 4 by means of the connection means 9. As illustrated in FIGS. 6 and 7, in the interior of the burner mounting unit 45, a gas circulation space 46 having an internal diameter larger than that of the main body 40 of the tower 4 is provided while a ring-like threshold member 47 is provided at the boundary between the gas circulation space 46 and the internal space of the main body 40. The third combustion burner 12 is attached to the burner mounting unit 45 such that the combustion gas flows in the gas circulation space 46, which is located inside the burner mounting unit 45 and outside the threshold member 47. Similar to the first and second combustion burners 10 and 11, the third combustion burner 12 also has a known structure such that it includes a pilot burner for preliminary burning and a main burner for main burning. As for the third combustion burner 12, the direction of the gas outlet 12A is determined such that the combustion gas is discharged in a tangential direction of the cylindrical burner mounting unit 45 and whirls along the inner peripheral surface of the burner mounting unit 45. The upper and lower surfaces of the threshold member 46 are provided with a plurality of concave grooves 48, respectively. Each groove 48 communicates between the gas circulation space 46 and the internal space of the main body 40. The high-temperature combustion gas injected from the third combustion burner 12 into the gas circulation space 46 is introduced into the internal space of the main body 40 through each groove 48.

In FIG. 6, the upper and lower surfaces of the threshold member 47 are provided with grooves 48, which communicate between the gas circulation space 46 and the internal space of the main body 40 however, the arrangement thereof is not limited thereto. For example, the threshold member 47 may have on its side wall through holes communicating between the internal space of the main body 40 and the gas circulation space 46.

In the valuable metal recovery apparatus 1 of FIG. 6, the side wall of the main body 40 of the tower 4 is provided with air supply openings 70 for introducing air from the outside. In this embodiment, a plurality of air supply openings 70 are provided generally at equal intervals in circumferential directions of the cylindrical main body 40. The flow rate of the air introduced from each air supply opening 70 can be controlled by adjusting the opening of the valve 72 attached to the pipe 71 connected to each air supply opening 70.

In the valuable metal recovery apparatus 1 of FIG. 6, upon heating of the heating container 3 by the first combustion burner 10, valuable metals contained in the waste in the heating container 3 are melted while combustible waste, such as oils, coating compositions, and plastic, other than valuable metals, is thermally decomposed into a gas, released from the heating container 3, and then discharged into the tower 4 as unburned gas. The unburned gas discharged into the tower 4 is first burned by the combustion gas from the third combustion burner 12 attached to the burner mounting unit 45. At this time, by introducing air from the air supply openings 70 into the tower 4, the gas can be satisfactorily burned. The mixed gas of the combustion gas generated in the tower 4 and the unburned gas that was not burned therein is discharged from the gas outlet 44 into the gas combustion chamber 5 via the gas discharge passage 6.

In the gas combustion chamber 5, the unburned gas in the mixed gas is burned into combustion gas by the combustion gas from the second combustion burner 11. Subsequently, combustion gas that was burned and the unburned gas that was not burned in the gas combustion chamber 5 are introduced from the gas outlet 53 into the furnace body 2 through the gas introducing passage 7. In the furnace body 2, the unburned gas in the mixed gas is burned by the combustion gas from the first combustion burner 10. Thereby, the unburned gas is completely burned to be effectively used as a heat source for heating the heating container 3 with the combustion gas contained in the mixed gas introduced into the furnace body 2, after which it is discharged from the flue 21.

In the valuable metal recovery apparatus 1 of FIG. 6, the unburned gas generated upon burning of the waste is burned in the tower 4 by the combustion gas from the third combustion burner 12 (primary combustion), further burned in the gas combustion chamber 5 by the combustion gas from the second combustion burner 11 (secondary combustion), additionally burned in the furnace body 2 by the combustion gas from the first combustion burner 10 (third combustion), and thereafter discharged from the flue 21. Therefore, in the whole apparatus, sufficient time for burning the unburned gas is further ensured, enabling the exhaust gas discharged from the flue 21 to be made cleaner.

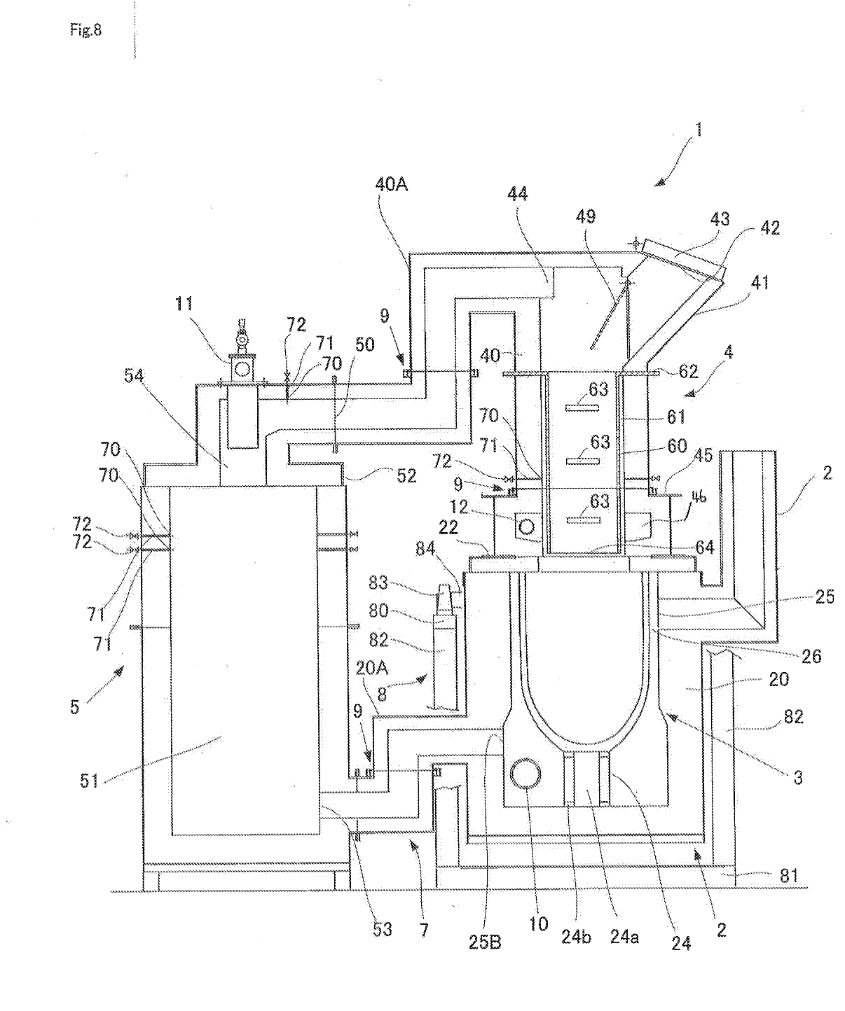

FIG. 8 illustrates an example of a modification of the valuable metal recovery apparatus 1 of FIG. 6. In the valuable metal recovery apparatus 1 illustrated in FIG. 8, a cylindrical inner tube 60 having openings at both ends is disposed inside the main body 40 of the tower 4, in place of the threshold member 47. The inner tube 60 has an outer diameter smaller than the internal diameter of the main body 40, and a space 61 is formed between the peripheral surface of the inner tube 60 and the inner peripheral surface of the main body 40. The inner tube 60 has at its upper end a flange portion 62, by which the inner tube is supported within the main body 40 in a suspended state. The lower end of the inner tube 60 extends towards the burner mounting unit 45.

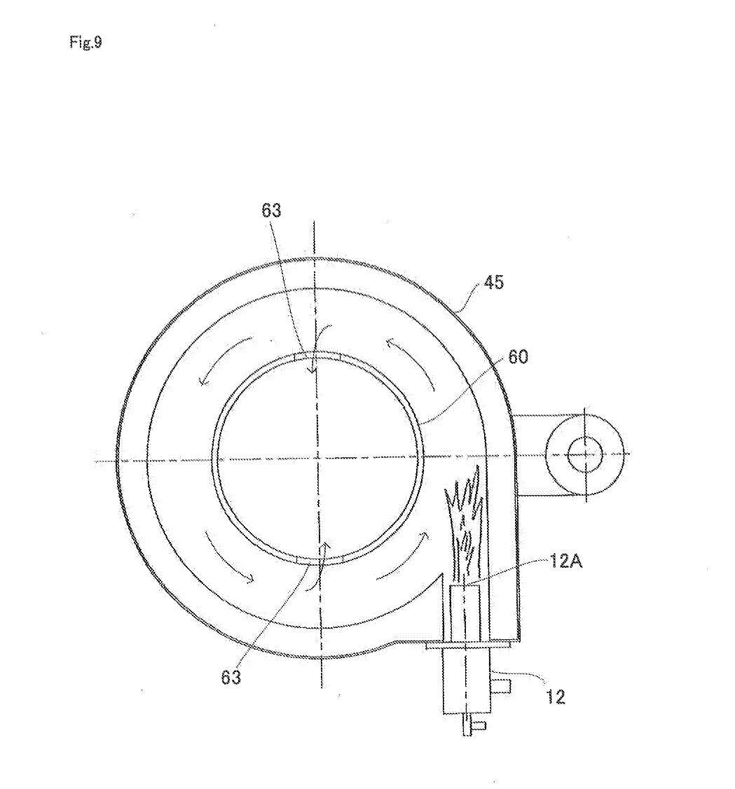

On the peripheral surface of the inner tube 60, a plurality of slit-like openings 63 are formed. As illustrated in FIG. 9, the combustion gas discharged from the third combustion burner 12 flows and circulates along the inner peripheral surface of the burner mounting unit 45; a portion thereof flows into the inner tube 60 from the lower opening 64 of the inner tube 60 while the majority thereof goes up through the space 61 between the inner tube 60 and the main body 40 and flows into the inner tube 60 from each opening 63.

In the valuable metal recovery apparatus 1 of FIG. 8, the unburned gas generated upon heating of the heating container 3 is discharged into the inner tube 60. The unburned gas discharged into the inner tube 60 is burned by the combustion gas that comes from the third combustion burner 12 and that flows into the inner tube 60 through the openings 63 and the lower opening 64. As a result, a mixed gas of the combustion gas and the unburned gas that was not burned is discharged from the gas outlet 44 into the gas combustion chamber 5 via the gas discharge passage 6.

The subsequent treatment of the unburned gas is the same as that employed in the valuable metal recovery apparatus 1 of FIG. 6 described above, and the detailed description is thus omitted here. In the valuable metal recovery apparatus 1 of FIG. 8 also, the unburned gas generated upon burning of the waste is burned in the tower 4 by the combustion gas from the third combustion burner 12 (primary combustion), burned in the gas combustion chamber 5 by the combustion gas from the second combustion burner 11 (secondary combustion), additionally burned in the furnace body 2 by the combustion gas from the first combustion burner 10 (third combustion), and is thereafter discharged from the flue 21. Thereby, the unburned gas can be completely burned.

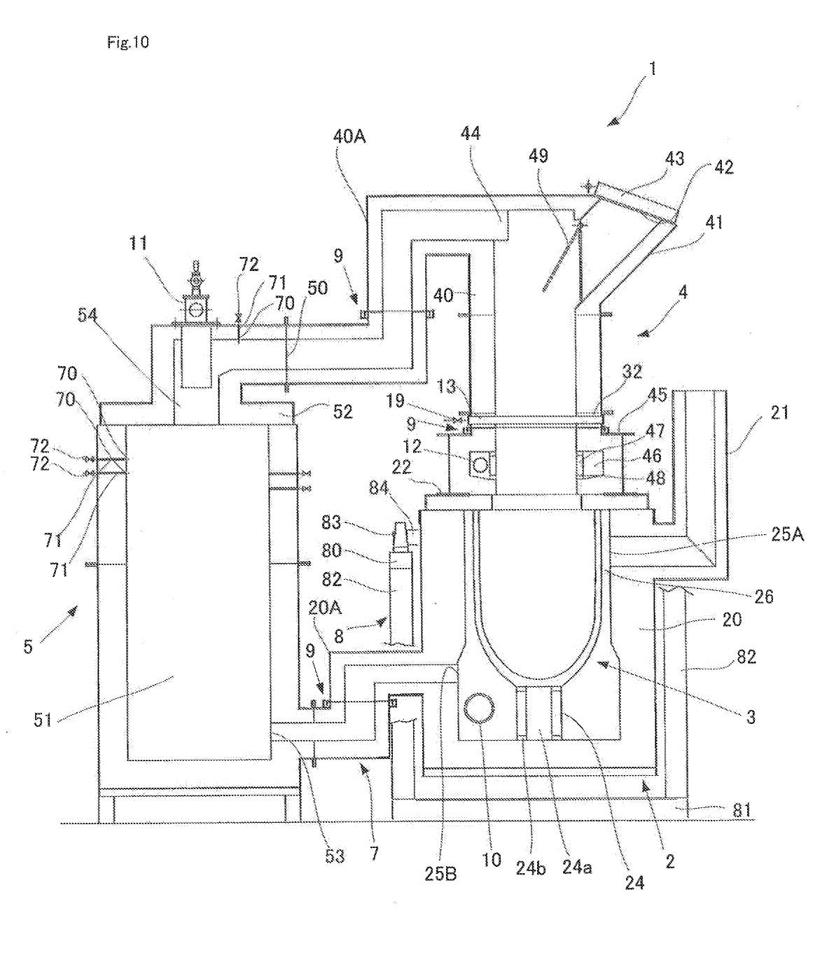

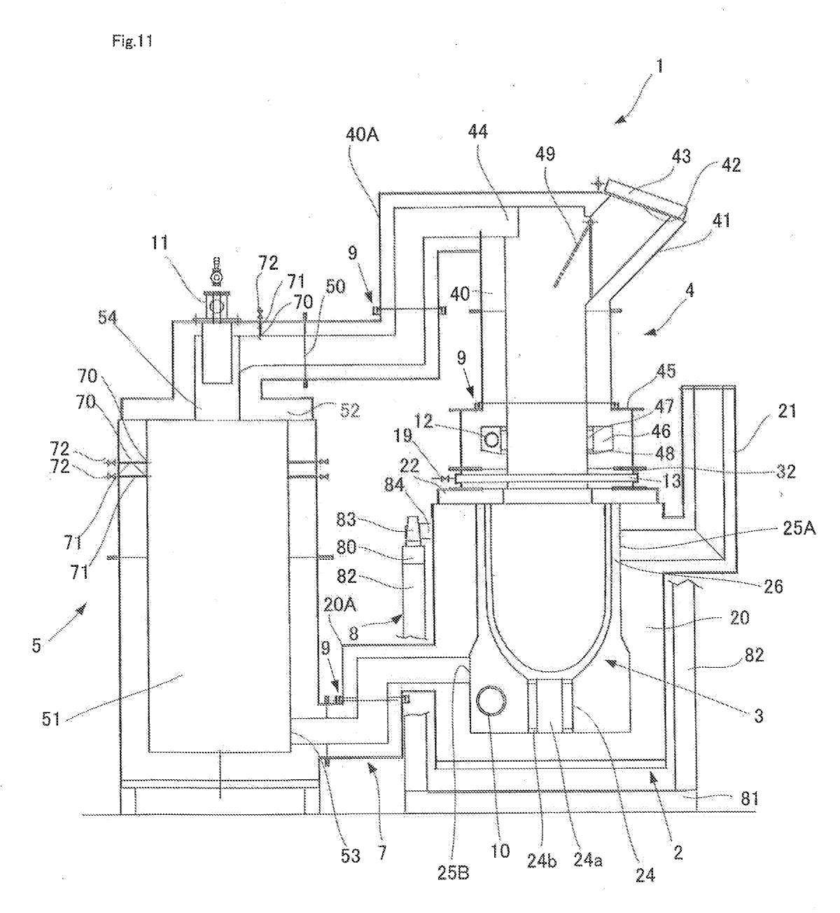

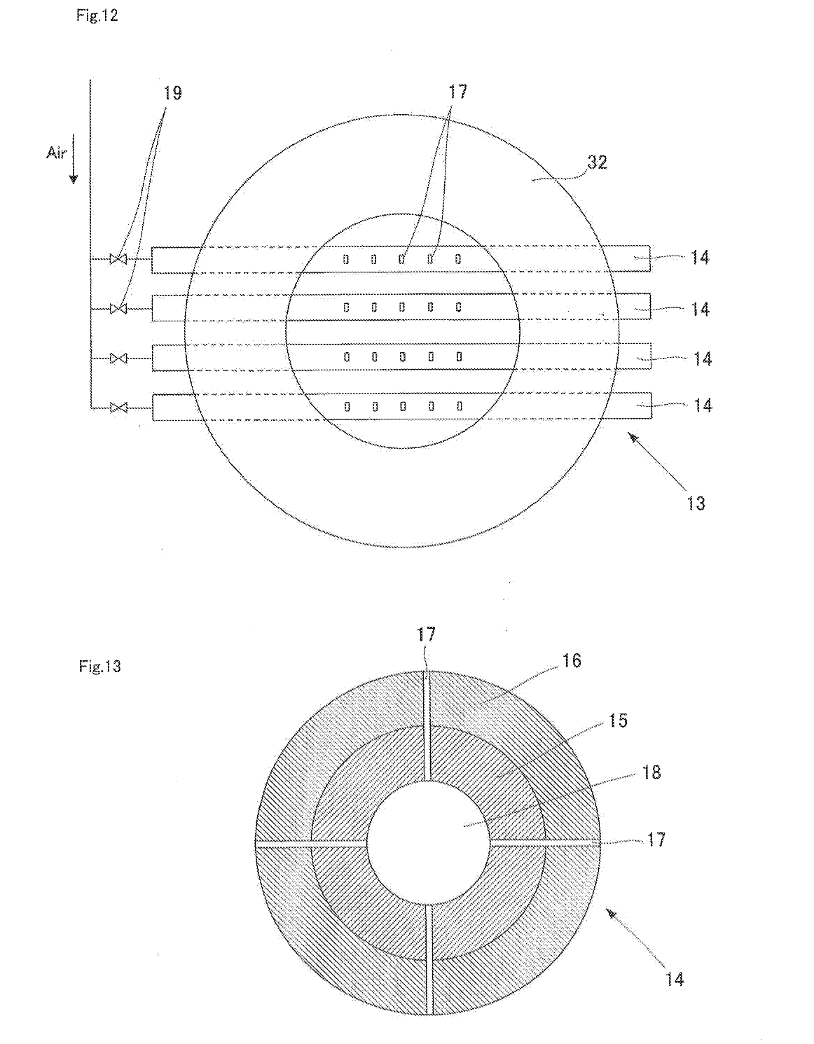

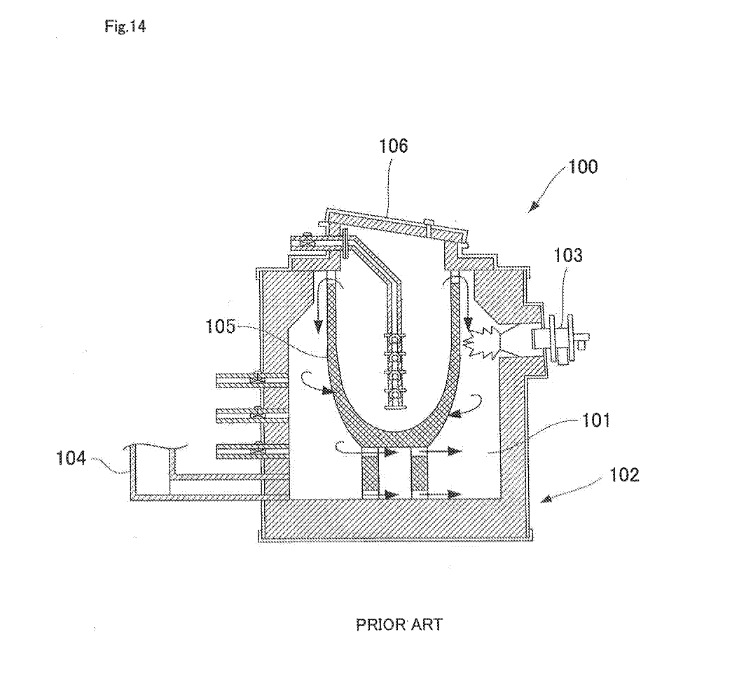

In the valuable metal recovery apparatus 1 of FIG. 6, a lattice 13 formed from a plurality of rod-shaped members 14 may be provided within the tower 4 (see FIGS. 10 and 11). The valuable metal recovery apparatus 1 of FIG. 10 is an example in which the lattice 13 is disposed directly above the third combustion burner 12. As illustrated in FIGS. 12 and 13, the lattice 13 is formed such that the plurality of rod-shaped members 14 are arranged parallel to or crossing one another at predetermined intervals. Each rod-shaped member 14 is supported by a ring-like support member 32. In FIG. 10, the support member 32 is fixed between the main body 40 of the tower 4 and the burner mounting unit 45 of the furnace body 2 (in FIG. 11, between the burner mounting unit 45 of the furnace body 2 and the lid 22). A plurality of through holes are formed on the side wall of the support member 32. By inserting the rod-shaped members 14 into the through holes, each rod-shaped member 14 is arranged at a predetermined interval within the main body 40 of the tower 4. Each of the rod-shaped members 14 is formed from a pipe-shaped stem 15 having a cavity inside, and a refractory layer 16 covering the stem 15. The stem 15 is made of metal, and the refractory layer 16 is made of, for example, a fire-resistant castable or fire-resistant plastic. At a region located within the main body 40 of the tower 4, each rod-shaped member 14 has on its peripheral surface a plurality of through holes 17 communicating between the inside and outside of the rod-shaped member 14. The cavity of each rod-shaped member 14 is connected to a pipeline from an air supply source (not shown), and air is supplied from the air supply source. The cavity serves as a flow path 18 for air to flow therethrough. The air that flows through the flow paths 18 is supplied into the tower 4 via each through hole 17. The amount of air supplied into each of the flow paths 18 can be adjusted by means of each valve 19.

In the valuable metal recovery apparatus 1 of FIG. 10, at least a portion of the waste introduced into the main body 40 from the input port 41 of the tower 4 temporarily stays on the lattice 13. If a large amount of waste is introduced into the heating container 3, the first combustion burner 10 alone is weak as a heat source to heat the waste to a high temperature. In particular, if the waste includes many organic substances, such as organic coating compositions, plastic, and rubber, a large amount of unburned gas will be generated. For this reason, the lattice 13 is provided within the tower 4 to allow at least a portion of the introduced waste to stay on the lattice 13. The waste on the lattice 13 can be heated to a high temperature by the combustion gas from the third combustion burner 12. As such, the heat treatment of the waste can be dispersed between two of the combustion burners 10 and 12. As a result, even if a large amount of waste is introduced into the tower 4, a lack of power in the heat source for heating the waste to a high temperature can be prevented. At this time, air is introduced into the tower 4 from each through hole 17 of each rod-shaped member 14, and the unburned gas can thus be completely burned in a satisfactory manner.

When waste contains iron, etc., in addition to aluminum, because iron is less easily melted than aluminum, by allowing the waste to temporarily stay on the lattice 13 while the combustion temperature of the third combustion burner 12 is being adjusted to achieve melting of only the aluminum in the waste, it is possible to recover only melted aluminum in the heating container 3. In this manner, aluminum with small amounts of impurities can be recovered.

As illustrated in FIG. 11, the lattice 13 may also be disposed directly under the third combustion burner 12.

In the valuable metal recovery apparatus 1 of all the embodiments described above, the main body 40 may have a plurality of input ports 41. For example, the plurality of input ports 41 may be radially disposed from the center of the main body 40. In this way, it becomes easy to drop waste dispersively and uniformly into the heating container 3. Rather than providing the input port 41 on the side wall of the main body 40, the input port may be positioned such that waste drops from the top of the main body 40.

The input port 41 may have a double lid structure having an input lid 43 and an inner lid 49 as indicated by the long dashed double-short dashed line in FIGS. 1, 5, 6, 8, 10, and 11. A storage space capable of storing waste is provided between the input lid 43 and the inner lid 49. The inner lid 49 is provided such that it can be opened inwardly of the main body 40 of the tower 4. While the inner lid 49 is closed, the storage space and the main body 40 are disconnected; and when the inner lid 49 is opened as indicated by the long dashed double-short dashed line in FIGS. 1, 5, 6, 8, 10, and 11, the storage space communicates with the main body 40.

In this embodiment, when waste is introduced, the input lid 43 is opened while the inner lid 49 is closed so that the waste is allowed to be stored in the storage space. Then, when the input lid 43 is sealed and the inner lid 49 is opened, the waste stored in the storage space is dropped into the heating container 3. As such, in this embodiment, the inner lid 49 is kept closed whenever waste is introduced. This prevents unburned gas within the tower 4 from being released to the outside when the input lid 43 is opened. The opening and closing of the inner lid 49 may be mechanically interlocked with the opening and closing of the input lid 43. This can reliably prevent the unburned gas from being released.

In the valuable metal recovery apparatus 1 of all the embodiments described above, the heating container 3 is formed of a graphite crucible. However, it is also possible to use an inexpensive iron container having excellent thermal conductivity when waste with a low melting temperature, such as zinc or a low melting point aluminum alloy, is melted. As the heating container 3, for example, a fire-resistant ceramic container, or a container made of metal other than iron may also be used in addition to the above.

Similar to the valuable metal recovery apparatus 1 of the embodiment of FIG. 6, in the valuable metal recovery apparatus 1 of the embodiment of FIG. 1, the main body 40 may have on its side wall an air supply opening 70 for introducing outside air.

### EXPLANATION OF REFERENCE NUMERALS

1 Valuable Metal Recovery Apparatus
2 Furnace Body
3 Heating Container
4 Tower
5 Gas Combustion Chamber
6 Gas Discharge Passage
7 Gas Introducing Passage
8 Support
9 Connection Means
10 First Combustion Burner
11 Second Combustion Burner
12 Third Combustion Burner
13 Lattice
14 Rod-shaped Member
17 Through Hole
18 Gas Flow Passage
21 Flue
42 Input Port
45 Burner Mounting Unit
47 Threshold Member
48 Communication Path
50 Gas Inlet
60 Inner Tube
63 Opening
91 Insertion Member
92 Receiver
93 Heat Insulating Material

1. A valuable metal recovery apparatus comprising:
a heating container for storing a material to be treated;
a furnace body accommodating the heating container;
a first combustion burner for supplying heated gas into the furnace body to heat the heating container;
a cylindrical tower detachably provided above the furnace body, the cylindrical tower having an input port for introducing a material to be treated, and the cylindrical tower being used for receiving unburned gas generated upon heating of the material to be treated;
a gas combustion chamber communicating with the tower, the gas combustion chamber being used for receiving the unburned gas from the tower;
a second combustion burner for supplying heated gas into the gas combustion chamber to burn the unburned gas;
a gas introducing passage for introducing combustion gas generated in the gas combustion chamber into the furnace body;
a flue integrally provided with the furnace body, the flue being used for discharging the combustion gas in the furnace body to the outside; and
a support supporting the furnace body such that the furnace body can be tilted.

2. The valuable metal recovery apparatus according to claim 1, wherein the furnace body has a third combustion burner that is disposed above the heating container and that is used for supplying heated gas to burn the unburned gas discharged into the tower.

3. The valuable metal recovery apparatus according to claim 1, wherein the tower and the furnace body are detachably connected by a connection means,
the connection means comprising:
an insertion member provided on the outer peripheral surface of the tower,
a receiver provided on the outer peripheral surface of the furnace body, the receiver being used for receiving the insertion member, and
an elastic heat insulating material provided inside the receiver, and
wherein when the insertion member is inserted into the heat insulating material, the tower and the furnace body are airtightly connected to each other.

4. The valuable metal recovery apparatus according to claim 3, wherein the heat insulating material comprises ceramic fibers.

5. The valuable metal recovery apparatus according to claim 2, further comprising a lattice formed from a plurality of rod-shaped members, the lattice being disposed within the tower, such that at least a portion of the material to be treated introduced from the input port can temporarily stay on the lattice.

6. The valuable metal recovery apparatus according to claim 5, wherein the lattice is disposed directly above or directly below the third combustion burner.

7. The valuable metal recovery apparatus according to claim 5, wherein the rod-shaped member is formed in a pipe shape so as to have an internal passage for air, the rod-shaped member having on its peripheral surface at least one through hole for discharging air that flows through the passage to the outside of the rod-shaped member.

8. The valuable metal recovery apparatus according to claim 2, wherein the furnace body has between itself and the tower a burner mounting unit having an internal diameter greater than that of the tower, the burner mounting unit being provided with the third combustion burner for supplying heated gas into the burner mounting unit.

9. The valuable metal recovery apparatus according to claim 8, wherein the burner mounting unit has in its interior a ring-like threshold member, and wherein the third combustion burner is disposed such that heated gas flows outside the threshold member, the threshold member being provided with a communication path communicating between the inside and outside of the threshold member.

10. The valuable metal recovery apparatus according to claim 8, wherein the tower accommodates a cylindrical inner tube such that a space is formed between the inner tube and the inner peripheral surface of the tower, and wherein the third combustion burner is disposed such that heated gas flows outside the inner tube, the inner tube having on its outer peripheral surface slit-like openings for introducing heated gas supplied from the third combustion burner into the inner tube.

11. The valuable metal recovery apparatus according to claim 1, wherein the second combustion burner is disposed in the vicinity of a gas outlet of the tower.
